(19) United States
(12) Patent Application Publication
(10) Pub. No.: US 2026/0334518 A1
(43) Pub. Date: Oct. 29, 2026

(54) OIL-IN-WATER EMULSIFIED FOOD COMPOSITION COMPRISING BEETROOT VINEGAR

(71) Applicant: Conopco, Inc., d/b/a UNILEVER, Hobbken (JE)

(72) Inventors: Alessia ERMACORA, Wageningen (NL); Donaldus MERKX, Beuningen (NL); Ingrid SCHAEFFERS, Maassluis (NL); Sabrina SILVA PAES, Amersfoort (NL)

(73) Assignee: Conopco, Inc., d/b/a UNILEVER, Hoboken, NJ (US)

(21) Appl. No.: 19/113,481

(22) PCT Filed: Aug. 15, 2023
(86) PCT No.: PCT/EP2023/072451

§ 371 Date: Mar. 20, 2025

(30) Foreign Application Priority Data
Sep. 23, 2022 (EP) 22197341.5

(51) Int. Cl. A23L 27/60

(52) U.S. Cl. CPC A23L 27/60

(57) ABSTRACT

Oil-in-water emulsified food composition comprising vegetable oil, water, emulsifier, vinegar from Beta vulgaris subsp. vulgaris, Conditiva Group, having a pH of from 2 to 5.

The present invention relates to an oil-in-water emulsified food composition, a process of making the food composition and to the use of beetroot vinegar to reduce oil oxidation in a water-in-oil-emulsified food composition.

### BACKGROUND

Oil-in-water emulsified food compositions are popular as sauces such as salad dressings, mayonnaises and mayonnaise-like variants that comprise for example a low oil level or an emulsifier different than egg yolk. Such compositions are homogenous mixtures of oil droplets in a continuous water phase, wherein an emulsifier, typically egg yolk, prevents the oil droplets from coalescing. Coalescence of oil droplets results in phase separation of the emulsion, referred to as instability of the emulsions. Such oil-in-water emulsified compositions may comprise low or high levels of oil, up to levels of 85 wt %.

A problem observed in these oil-in-water emulsified food compositions is oxidation of the oil. Addition of ethylenediaminetetraacetic acid (EDTA) is a known remedy against this oxidation, but its presence is not desired by many consumers, who desire a product with as few as ‘chemical’ ingredients as possible and prefer reduction or even absence of EDTA.

Oil oxidation is a phenomenon that is not well understood. Although several compounds have been described as ‘anti-oxidants’ in the literature, the effectiveness of such an ‘antioxidant’ appears to depend heavily on the environment wherein it is present and the material that needs to be protected against oxidation. For example, a compound used in in vivo situations, as a food supplement, to reduce for example the impact of free radicals on sub-cellular molecules and structures to reduce the risk of cancer, is not automatically effective as anti-oxidant in a mayonnaise to reduce the oxidation of vegetable oil. In this context, reference is made to a review paper of Ghorbani Gorji et al., Trends in Food Science & Technology 56 (2016) 88-102) wherein for example the well-known antioxidant vitamin c is indicated as having no effect on reduction of oil oxidation in mayonnaise, because the oil is present in an emulsion with water. In fact, the specific emulsion environment renders it a pro-oxidant. Also, the pH of the composition appears to influence the effectivity of potential anti-oxidant compounds. The risk and impact of oil oxidation may in particular be pronounced in industrially prepared oil-in-water emulsions, because of the very small droplet size of below 10 micron and the concomitant high surface area. It therefore remains an unpredictable approach to find a suitable antioxidant compound that can replace as much as possible of the EDTA in oil-in-water emulsified compositions, such as dressings like mayonnaise.

An additional complication in this respect is that the desired oil-in-water emulsions typically have a light color, for example light yellow to off-white or white, to resemble the color of traditional dressing compositions such as mayonnaise. The influence of the antioxidant-providing ingredients on the color of the oil-in-water emulsion therefore should be as little as possible, and preferably not noticeable by the human eye, compared to an equivalent composition without the anti-oxidant-providing ingredient but using EDTA. In addition, the mouthfeel of the dressing, preferably the mayonnaise, preferably is not affected, and the oil in water emulsion preferably has a smooth, e.g. not a sandy or grainy, texture, similar to that of a traditional dressings emulsion, such as mayonnaise. The compositions of the present invention preferably do not show a specific off-taste as a consequence of the use of the anti-oxidant-providing ingredient.

Several attempts have been described to reduce or replace EDTA in oil in water emulsions.

WO2018/189709 describes the use of reduced grape juice, including grape balsamic vinegar, as antioxidant ingredient, to reduce the level of EDTA in oil-in-water emulsified food compositions.

WO2019/057407 describes oil-in-water emulsions comprising vinegars. It was described that some chemically defined vinegars had high anti-oxidative effect in an oil-in-water emulsified food composition, and could replace EDTA to a significant extent.

WO2019/057474 describes an oil-in-water emulsion that contains apple cider vinegar that meets specific marker compounds. Such vinegars appeared successful in inhibiting oil oxidation in the context of oil-in-water emulsions to a significant extent.

Although these patent applications describe vinegars with strong anti-oxidative effect in oil-in-water emulsified food compositions, a need remains for an oil-in-water emulsified food composition wherein the amount of EDTA can be as low as possible, preferably wherein EDTA can be absent, because of the presence of an antioxidant ingredient that is perceived as natural by consumers in the context of and oil-in-water-emulsified food compositions.

### SUMMARY OF THE INVENTION

Surprisingly, this challenge was met, in a first aspect, by an oil-in-water emulsified food composition according to the invention. Accordingly, in a first aspect, the invention relates to an oil-in-water emulsified food composition comprising:
From 3 to 87 wt % of vegetable oil,
Water,
Oil-in-water emulsifier,
Vinegar from B. vulgaris subsp. vulgaris Conditiva Group,
wherein the food composition has a pH value between 2 and 5.

In a further aspect, the present invention relates to a process to provide an oil-in-water emulsion, the process comprising the steps of:
a) Providing a mixture comprising
   vegetable oil,
   water,
   vinegar from B. vulgaris subsp. vulgaris Conditiva Group, wherein the vinegar comprises betaine,
   oil-in water emulsifier,
b) Homogenizing to result in an oil-in-water emulsion.

In a further aspect, the invention relates to the use of vinegar from B. vulgaris subsp. vulgaris Conditiva Group, preferably red beetroot vinegar, in an oil-in-water emulsion comprising from 3 to 87 wt % vegetable oil, to achieve at least 50%, preferably at least 75% of the antioxidative effect as obtained by 75 ppm EDTA in an equivalent composition.

### DETAILED DESCRIPTION

All percentages, unless otherwise stated, refer to the percentage by weight (wt %).

Except in the operating and comparative examples, or where otherwise explicitly indicated, all numbers in this description indicating amounts or ratios of material or conditions of reaction, physical properties of materials and/or use are to be understood as modified by the word “about”.

Features described in the context of one aspect of the invention can be applied in another aspect of the invention.

Unless otherwise specified, numerical ranges expressed in the format “from x to y” are understood to include x and y. In specifying any range of values or amounts, any particular upper value or amount can be associated with any particular lower value or amount.

### Emulsion

The composition of the invention is in the form of an oil-in-water emulsion. Examples of oil-in-water emulsions encompassed by the present invention include emulsified sauces, such as mayonnaise, and dressings, such as salad dressings and vinaigrettes. Preferably, the food composition is an emulsified sauce or dressing, preferably a mayonnaise or salad dressing and most preferably is a mayonnaise.

Mayonnaise is generally known as a thick, creamy sauce that can be used as a condiment with other foods. Mayonnaise is a stable water-continuous emulsion of typically vegetable oil, egg yolk and either vinegar or lemon juice. In many countries the term mayonnaise may only be used in case the emulsion conforms to the “standard of identity”, which defines the composition of a mayonnaise. For example, the standard of identity may define a minimum oil level, and a minimum egg yolk amount. Mayonnaise-like products, e.g. having oil levels lower than defined in a standard of identity or not containing egg yolk, are considered to be mayonnaises in the context of the present invention. This kind of products may contain thickeners like starch to stabilise the aqueous phase. Mayonnaises may vary in colour, and are generally white, cream-coloured, or pale yellow. The texture may range from light creamy to thick. Generally, mayonnaise is spoonable. In the context of the present invention “mayonnaise” includes such mayonnaise and ‘mayonnaise-like’ emulsions. Mayonnaises in the context of the present invention do not necessarily need to conform to a standard of identity in any country.

### Oil

The oil-in-water emulsified food composition according to the invention comprises vegetable oil. Vegetable oil is preferably present in an amount of from 5 to 85 wt %, preferably 10 to 85 wt %, preferably of from 13 to 82 wt %, even more preferably of from 65 to 82 wt %, most preferably of from 70 to 80 wt %, based on the weight of the food composition.

Vegetable oil is known in the art, and includes oils derived from e.g. plants, such as from for example nuts or seeds from plants. In the context of this invention, ‘vegetable oil’ also includes oil from algae. Preferred oils for use in the context of this invention are vegetable oils which are liquid at 20 °C, preferably, which are liquid at 5 °C. Preferably the oil comprises an oil selected from the group consisting of sunflower oil, rapeseed oil, olive oil, soybean oil, and combinations of these oils. Most preferred, the oil is soybean oil or rapeseed oil.

### Water

The composition of the invention comprises water. The total amount of water in the composition is preferably of from 12 to 95 wt %, preferably of from 14 to 90 wt %. It can be preferred that water is present in a total amount of from 15 to 85 wt %, preferably in an amount of from 15 to 33 wt %, or even more preferably 17 to 25 wt %. Preferably the total amount of water is at least 14 wt %, more preferably at least 15% by weight, even more preferably at least 17%. It may be preferred that the amount of water is at least 20 wt %, e.g. if relatively low oil levels are preferred. Preferably, the concentration of total water is maximally 95 wt %, more preferably at most 90 wt %, even more preferably at most 85 wt %, more preferably at most 33 wt % or more preferred at most 25 wt %. Any combination of ranges using these mentioned end points are considered to be part of the invention as well. “Total amount of water” includes water originating from water-containing ingredients.

### Emulsifier

Preferably the composition of the invention comprises an oil-in-water emulsifier. The emulsifier is preferably present in an amount of from 0.01 to 15 wt %, preferably 0.1 to 12 wt %, based on the weight of the oil-in-water emulsion. The emulsifier serves to disperse oil droplets in the continuous aqueous phase of an oil-in-water emulsion. The emulsifier preferably has a hydrophilic-lipophilic balance (HLB) of from 8 to 15, more preferably of from 10 to 14 and even more preferably of from 11 to 13. The Hydrophilic-Lipophilic Balance (HLB) of an emulsifier is a measure of the degree to which it is hydrophilic or lipophilic. The HLB value is a parameter which is describing the solubility of the surfactant. The HLB value is described by Griffin in 1950 as a measure of the hydrophilicity or lipophilicity of nonionic surfactants. It can be determined experimentally by the phenol titration method of Marszall; see “Parfumerie, Kosmetik”, Vol. 60, 1979, pp. 444-448; and Rompp, Chemistry Lexicon, 8th Edition 1983, p. 1750.

Preferably the emulsifier comprises, more preferably is an oil-in-water emulsifier originating from egg, preferably from egg yolk. Preferably the composition comprises egg yolk, more preferably is egg yolk. This suitably serves as an ingredient which also provides the oil-in-water emulsifier. The presence of egg yolk may be beneficial for taste, emulsification and/or stability of the oil droplets in the composition of the invention. Egg yolk contains phospholipids, which act as emulsifier for the oil droplets.

Preferably the concentration of egg yolk in the composition of the invention ranges from 1% to 10% by weight of the composition, more preferred from 2% to 8% by weight of the composition, even more preferably from 2.5% to 6% by weight of the composition. The egg yolk may be added as egg yolk component. Alternatively, the composition may also contain whole egg, containing both egg white and egg yolk. The total amount of egg yolk in the composition of the invention includes egg yolk that may be present as part of whole egg. Preferably the concentration of phospholipids, preferably originating from egg yolk, ranges from 0.08% to 0.8% by weight, preferably from 0.2% to 0.5% by weight of the food composition.

Alternatively, or in addition to the egg-derived emulsifier, the composition of the invention may comprise an emulsifier that does not originate from egg or egg yolk. Such non-egg derived emulsifier may be derived from dairy, such as preferably whey protein or casein.

It may be preferred, that the composition of the invention is free from egg-derived emulsifier, and free from dairy protein. Preferably the oil-in-water emulsifier is from plant or botanical origin, and may be used native or modified. In this way a vegan oil-in-water emulsion can be created without ingredients from animal origin. Preferably the oil-in-water emulsifier comprises starch sodium octenyl succinate (European food additive E1450). This emulsifier is available commercially as for example N-creamer 46, ex Ingredion Inc. (Westchester, IL, USA).

It can also be preferred that the emulsifier is a plant-based emulsifier, such as a plant protein. Preferably plant protein is present in the composition in an amount of from 0.3 to 5 wt %, based on the weight of the composition. Preferably, the amount of plant protein is of between 0.5 and 2.5 wt %, preferably of between 0.7 and 1.5 wt %, based on the weight of the composition. An amount for example may be preferred of more than 0.5 wt %. An amount may be preferred of less than 1.1 wt %, based on the weight of the composition.

The plant protein is preferably selected from the group consisting of pulse protein, oil seed protein, potato protein and mixtures thereof. Preferably the plant protein is pulse or potato protein. Pulse is the family of Fabaceae. Pulse protein is preferably selected from the group consisting of pea protein, lentil protein, chickpea protein, lupin protein, faba bean protein, soy protein and mixtures thereof. Pulse protein is preferably present in a total amount of from 0.01 to 2 wt %, more preferably in an amount of from 0.03 to 1.5 wt %, based on the weight of the oil in water emulsion. More preferably, the plant protein is selected from the group consisting of potato protein, pea protein, chickpea protein, lentil protein, soy protein and mixtures thereof. It can however be preferred that the composition does not comprise soy protein. Preferably pulse protein is selected from the group consisting of pea protein, lentil protein, chickpea protein and mixtures thereof. More preferably the pulse protein is selected from the group consisting of pea protein, lentil protein and mixtures thereof. Most preferred, the pulse protein is pea protein (Pisum sativum).

Oil seed protein is preferably selected from the group consisting of rape seed protein, canola protein and mixtures thereof, preferably is rape seed protein.

Even more preferably, the emulsifier is selected from the group consisting of pea protein, chickpea protein, lentil protein, egg yolk and mixtures thereof.

The food composition of the invention preferably comprises an emulsifier selected from the group consisting of egg yolk, dairy protein, botanical protein (including plant and algae) and mixtures thereof. More preferably, the emulsifier is selected from the group consisting of phospholipid, whey protein, casein, algae protein, legume protein, OSA starch and mixtures thereof. Proteinaceous emulsifier such as whey protein, casein, algae protein, legume protein are preferably present in a total amount of from 0.01 to 2 wt %, more preferably in an amount of from 0.03 to 1.5 wt %, based on the weight of the oil in water emulsion.

### Beetroot Vinegar

The food composition of the invention requires the presence of vinegar from B. vulgaris subsp. vulgaris Conditiva Group. It was surprisingly found that vinegar prepared from beet of the cultivar Conditiva, in particular red beetroot (supsp. ruba), showed an unexpected capacity to reduce oxidation of vegetable oil droplets in an oil-in-water emulsion. Surprisingly, the white/off-white color of an oil-in-water emulsion, like a mayonnaise or mayonnaise-like product is not affected. For example, the emulsion does not color pink, red or purple, as one perhaps would expect.

Beetroot is one of several cultivated varieties of Beta vulgaris, and Beta vulgaris includes the Altissima Group (sugar beet), Flavescens Group (Swiss chard), Cicla Group (spinach beet or chard), Conditiva Group (beetroot or garden beet, includes the red root vegetable that is most typically associated with the word ‘beet’), and Crassa Group (mangelwurzel). The vinegar applied in the present invention accordingly is vinegar from the root of B. vulgaris subsp. vulgaris Conditiva Group. Beetroot is a well-known plant, and the root of the plant, which is typically colored dark red, is commonly used as a vegetable. In the present invention, beetroot vinegar refers to vinegar prepared from juice extracted from the root of B. vulgaris subsp. vulgaris Conditiva Group. Beetroot is to be distinguished from the sugar beet (Beta vulgaris subsp. vulgaris var. Altissima). Sugar beet is a common source for preparing sugar and is not the beetroot that is used in the present invention. Sugar, e.g. as refined from sugar beets, can be fermented into alcohol, which in turn can be fermented into vinegar. Such vinegar is well-known as spirit vinegar. Confusingly, spirit vinegar prepared from refined sugar derived from sugar beets is sometimes erroneously labelled as beet vinegar, beetroot vinegar or even red beetroot vinegar. Translation into or from different languages contributes to this confusion as well.

To prepare a fruit or vegetable vinegar, such as the vinegar from Beta vulgaris subsp. vulgaris, Conditiva group, preferably red beetroot vinegar, the first step is to make ‘wine’ out of the fruit or vegetable, wherein the whole fruit or vegetable or a part thereof is taken, preferably after washing it or comminuting it into sizeable parts. Then the juice is collected from the fruit or vegetable. The fruit or vegetable juice is subjected to ethanol fermentation based on conversion of sugar into alcohol, e.g. by fermentation using e.g. yeast, in the present invention preferably Saccharomyces cerevisiae. The fermentation process results in ethanol being present in the fruit or vegetable juice. This fermented fruit or vegetable juice is fermented by subjecting it to an acetic acid fermentation process, typically based on the conversion of ethanol into acetic acid, which is normally facilitated by acetic bacteria. In the present invention, the acetic acid fermentation is preferably facilitated by acetobacter bacteria or gluconobacter bacteria, preferably acetobacter, such as Acetobacter aceti. The amount of acetic acid in the beetroot vinegar used in the invention is preferably from 1.5 to 15 wt %, preferably from 1.5 to 10 wt %, even more preferably from 2 to 6 wt %, more preferably 2.5 to 5.5 wt %. The acetic acid content of the vinegar typically does not exceed 20 wt %. This concentration refers to the total concentration of the acid and its corresponding salt.

Lactic acid fermentation is preferably absent from the beetroot vinegar production used in the present invention, and lactic acid levels are preferably low or absent in the vinegar used in the invention and in the oil in water emulsion of the invention, for reasons of taste. The concentration of lactic acid in the vinegar from Beta vulgaris subsp. vulgaris Conditiva group, used in the invention, is preferably below 0.5 wt %, more preferably below 0.2 wt %, even more preferably below 0.1 wt %, based on the weight of the vinegar, and most preferably lactic acid is absent. The amount could preferably range from 0 to 0.5 wt %, preferably from 0.05 to 0.5 wt %, preferably from 0.05 to 0.2 wt %, preferably from 0.05 to 0.1 wt %, based on the weight of the vinegar. A detailed method to produce beetroot vinegar is given below.

It is conceivable for the skilled person, that for example a compound typically found in beets (e.g. red beetroot), betaine (trimethylglycine), can be found in vinegar that is produced using beet juice, but will not be present in spirit vinegar, which originates from refined sugar. Accordingly, the concentration of betaine in the beetroot vinegar used in this invention is preferably higher than 0.5 mg/g, preferably of between 0.9 and 3.5 mg/g. The concentration of betaine in the emulsified food composition (i.e. based on weight of the food composition) is preferably higher than 0.003 mg/g, preferably higher than 0.005 mg/g, more preferably higher than 0.008 mg/g, and even more preferably higher than 0.01 mg/g. The concentration in the food composition is preferably lower than 0.7 mg/g, more preferably lower than 0.4 mg/g, even more preferably lower than 0.2 mg/g. The concentration in the food composition is preferably of between 0.003 and 0.7 mg/g, more preferably of between 0.005 and 0.4 mg/g, and most preferably of between 0.01 and 0.2 mg/g. The vinegar preferably comprises DNA of beet of B. vulgaris subsp. vulgaris Conditiva Group, preferably of red beetroot. The emulsified food composition preferably comprises DNA of beet of B. vulgaris subsp. vulgaris Conditiva Group, preferably of red beetroot, also referred to as subsp. ruba.

The beetroot vinegar as used in the present invention preferably has a low sugar content, for example for reasons of taste or process efficiency. The sugar content in the beetroot vinegar used in the composition of the invention is preferably below 15 wt %, more preferably below 10 wt %, even more preferably below 5 wt %, even more preferably below 2 wt %, or even more preferably below 1 wt %, based on the weight of the beetroot vinegar (vinegar from Beta vulgaris, supsp. vulgaris, Conditiva group). It can be preferred that the beetroot vinegar is free from sugar. Sugar levels in the vinegar can be controlled by for example the duration that the ethanol fermentation is carried out. Without willing to be bound by theory, a more progressed fermentation process may result in better decolorization and better anti-oxidation capacity.

The ethanol concentration is preferably low. Some consumer groups may not prefer to consume ethanol. Preferably, the amount of ethanol in the beetroot vinegar used in the invention is from 0 to 2 wt %, preferably from 0 to 1.5 wt %, even more preferably from 0 to 1 wt %, even more preferably from 0 to 0.5 wt %. It is especially preferred, that the ethanol level is below 0.5 wt %, preferably below 0.2 wt %, more preferably below 0.1 wt %, based on the weight of the beetroot vinegar. It may be preferred that the beetroot vinegar is free from ethanol. Ethanol levels can be adjusted for example by the intensity or duration of the acetic acid fermentation, as the skilled person understands.

### Color

As set out above, it is desired that the antioxidant providing ingredient, i.e. the beetroot vinegar as applied in the composition according to the invention, does provide as little as possible of an off-color and preferably does not provide an off-color, such as a pink or purple color or hue, to the oil-in-water emulsion, preferably as judged by the naked eye. Color can be measured as known in the art according to a CIE L*a*b* scale. This is preferably assessed some weeks after production, when products are stabilized and typically on the shelf. In particular, compositions are preferred having a L*a*b* color value of the beetroot vinegar, wherein the L* value of the beetroot vinegar is higher than 0, preferably from 0 to 65, more preferably is from 2 to 45. The b* value is preferably more than 0, preferably of between 1 and 60, even more preferably of between 5 and 55. The a* value is preferably more than 0, preferably of between 5 and 45, even more preferably of between 10 and 40. Such L* values and b* values, preferably the combination of such L* and b* values of the beetroot vinegar provide food compositions according to the invention, especially mayonnaise compositions, which most resemble, with respect to color, the food compositions without the beetroot vinegar.

L* for oil-in-water emulsions according to the invention is preferably of from 50 to 95, preferably of from 70 to 95, even more preferably of from 80 to 94, most preferably of from 85 to 94. The difference in color ΔE between the color of a composition with and without the red beetroot vinegar is calculated as follows ΔE*=SQRT(ΔL*²+Δa+²+Δb*²). The difference in color ΔE between a composition with and without the vinegar from Beta vulgaris subsp. vulgaris, Conditiva Group, preferably red beetroot vinegar, calculated as ΔE*=SQRT(ΔL*²+Δa+²+Δb+²) is preferably of from 0 to 30, more preferably of from 0 to 20, even more preferably of from 0 to 10 and most preferably of from 0 to 5. These maximum differences in color ΔE are especially desired and preferred if the product is a mayonnaise or a salad dressing, but are not limited to these types of food product.

The red color in beetroot is caused by betalains, a group of color compounds that includes for example betacyanins, of which betanin is an example. In the present invention, their presence is not desired, as this provides an off-color, e.g. purple or pink color to the oil-in-water emulsion. Surprisingly, it was found by the inventors, that by the process of preparing a vinegar from the beetroot juice, the red color disappeared to such an extent, that the resulting vinegar could be used as an antioxidant in oil-in-water emulsified food compositions. Indeed, beetroot juice as such is not suitable and provides significant pink off-color to an oil-in-water emulsion. Accordingly, the amount of betanin in the beetroot vinegar is preferably below 0.01%, e.g. from 0 to 0.01 wt %, more preferably below 0.005 wt %, e.g. from 0 to 0.005 wt %, based on the weight of the beetroot vinegar, and most preferably is absent (0 wt %). Preferably the concentration of betanin in the oil-in-water emulsion is below 0.002, e.g. from 0 to 0.002, more preferably below 0.001 wt %, e.g. from 0 to 0.001 wt %, even more preferably below 0.0005 wt %, e.g. from 0 to 0.0005 wt %, even more preferably below 0.0001 wt %, e.g. from 0 to 0.0001 wt %, and preferably betanin is absent (0 wt %), based on the weight of the composition.

### Amount

The oil-in-water emulsified food composition according to the invention preferably comprises from 0.5 to 20 wt % of beetroot vinegar, i.e. vinegar prepared from root of B. vulgaris subsp. vulgaris Conditiva Group, preferably red beetroot. Preferably, the emulsion comprises from 0.5 to 10 wt % beetroot vinegar, preferably red beetroot vinegar, even more preferably of from 1 to 5 wt %, even more preferably of from 1 to 3 wt %, based on the weight of the oil-in-water emulsion.

### Acid and pH

The composition of the invention preferably has a pH ranging from 2.5 to 5, preferably ranging from 2.5 to 4.

Preferably the composition of the invention has a total titratable acidity ranging from 0.03% to 3% by weight expressed as acetic acid, preferably from 0.05% to 2% by weight, preferably from 0.1% to 1% by weight. Acetic acid is preferably present in an amount of more than 50 wt %, more preferably more than 80 wt %, even more preferably more than 90 wt %, even more preferably more than 95 wt % based on the weight of the total amount of acid in the composition.

### Other Ingredients

It may be preferred, that the composition of the invention contains additionally other ingredients than already specifically mentioned in here. For example, it may be preferred, that the composition contains plant material in the form of herbs and/or spices. In case such ingredients are present in the composition, then generally their total concentration is at least 0.1% by weight, and preferably maximally 10% by weight, preferably maximally 5% by weight.

The composition of the invention may comprise sugar. High levels are not desired. Sugar may be present in an amount of from 0.1 to 15 wt %, preferably of from 0.3 to 12 wt %, even more preferably of from 0.4 to 10 wt %, most preferably of from 0.5 to 8 wt %, based on the weight of the composition.

Total alkaline metal salt, preferably sodium chloride, may be present in an amount of from 0.1 to 5 wt %, preferably from 0.15 to 4 wt %, or more preferably of from 0.2 to 3 wt %, based on the weight of the composition.

The food composition of the invention may comprise a thickener. It may be preferred that the food composition comprises a thickener such as a hydrocolloid thickener. Therefore, the food composition may preferably comprise starch or gum or mixtures thereof. A preferred gum is xanthan gum. The composition may comprise starch (not being OSA starch) in an amount of from 0.1 to 8 wt %, preferably of from 0.2 to 7 wt %, more preferably of from 0.5 to 6 wt %, or even from 0.5 to 5 wt % can be preferred, based on the weight of the food product. It is preferred, that when starch or gum is present, the oil content is between 5 and 72 wt %, preferably of between 8 and 70 wt %, preferably of between 10 and 60 wt % based on the weight of the food product.

The amount of EDTA which commonly is present in oil-in-water emulsified compositions can be strongly reduced in compositions according to the invention. Hence, preferably the composition comprises EDTA at a concentration lower than 0.008 wt %, preferably from 0 to 0.007% by weight, preferably lower than 0.005% by weight, preferably from 0 to 0.005 wt %, preferably lower than 0.002% by weight, preferably from 0 to 0.002 wt % preferably lower than 0.001% by weight, preferably from 0 to 0.001 wt % of the composition. Most preferred EDTA is absent (0 wt %) from the composition.

The composition may comprise mustard, e.g. as a flavour compound. Mustard may be present for example in an amount of from 0.5 to 10 wt %, more preferably 1 to 9 wt %, even more preferably 2 to 8 wt %, even more preferably of from 3 to 7 wt %. Accordingly, it may be preferred that the food product of the invention comprises allyl isothiocyanate (AITC).

The rheological properties of the composition can be expressed in Stevens Value (in grams) and/or as elastic property. The Stevens Value (in grams), the consistency, is preferably of between 10 and 400 g, even more preferred between 50 g and 400 g, more preferably of between 100 and 200 g, and even more preferably of between 100 g and 150 g, as measured at 20 °C. Especially for mayonnaise and mayonnaise-like compositions, the Steven value is preferably from 50 to 400 g, preferably of from 50 to 200, even more preferably 100 to 200 g, or even 100 to 150 g, as measured at 20 °C. This is preferably assessed some time, e.g. a week, or 2 weeks, after production, when products are stabilized and typically on the shelf.

The consistency of the composition of the invention is preferably a consistency which is recognised by the consumer as the consistency of a mayonnaise, a sauce or of a salad dressing, preferably of a mayonnaise or a salad dressing, most preferably of a mayonnaise. The consistency of the compositions of the present invention can be described by their storage modulus G′, measured at 1 Hz and 20 °C, which is preferably within the range of 100-3500 Pa, more preferably in the range of 300-2000 Pa, most preferably in the range of 400-1500 Pa.

A preferred composition may be an oil-in-water emulsified food composition comprising:
From 3 to 87 wt % of vegetable oil,
water,
Oil-in-water emulsifier,
0.5 to 20 wt %, preferably 0.5 to 10 wt % red beetroot vinegar,
wherein the food composition has a pH of from 2 to 5,
wherein the composition comprises betaine.
wherein the concentration of EDTA is lower than 0.007 wt %
and wherein the oil droplets in the emulsion have a surface weighted mean diameter D3,3 of less than 10 micrometer.

### Process

The compositions of the invention can be prepared by any method commonly known for industrially preparing oil-in-water emulsions. Preferably, by using such method, an oil-in-water emulsion is prepared, wherein the oil droplets have a surface weighted mean diameter D3,3 of less than 10 micrometer (see M. Alderliesten, Particle & Particle Systems Characterization 8 (1991) 237-241; for definitions of average diameters). The droplet size can be measured for example with the technique of Van Duynhoven Eur. J. Lipid Sci Technol. 109, 2007, p 1095-1103.

Accordingly, in a second aspect the present invention provides a method for making an emulsified food composition according to the first aspect of the invention. Preferred compounds and amounts indicated in the first aspect of the invention apply for this aspect as well. The method comprises the steps of:
a) Providing a mixture comprising
   vegetable oil,
   water,
   vinegar from B. vulgaris subsp. vulgaris Conditiva Group,
   oil-in-water emulsifier,
b) Homogenizing,
to result in an oil-in-water emulsion.

Preferably, the method comprises the steps of:
a) Providing a mixture comprising:
   vegetable oil,
   water,
   vinegar from B. vulgaris subsp. vulgaris Conditiva Group,
   oil-in-water emulsifier,
b) Homogenizing,
to result in an oil-in-water emulsion,
wherein step a) comprises the steps of:
   Preparing a water phase comprising water and oil-in-water emulsifier,
   Preparing an oil phase comprising oil,
   Adding the oil phase to the water phase,
and wherein step b) comprises homogenizing the oil phase with the water phase to emulsify the oil phase into the water phase, preferably to an oil droplet size of D3,3 of below 10 micron, and
wherein vinegar from B. vulgaris subsp. vulgaris Conditiva Group, preferably red beetroot vinegar, is added in the water phase during step a) or is added during step b), preferably is added during step b).

In the context of the second aspect of the invention, water is preferably added (i.e. as ingredient) in step b) of the process in an amount of from 6 to 94 wt %, preferably of from 6 to 90 wt %, based on the weight of the resulting food composition. It can be preferred that water is added in a total amount of from 6 to 85 wt %, preferably in an amount of from 7 to 33 wt %, even more preferably of from 8 to 25 wt %, or even of from 8 to 20 wt %. Preferably the amount of added water is at least 6 wt %, more preferably at least 7% by weight, even more preferably at least 8%. It may be even preferably that the amount is at least 10 wt %, e.g. in case of relatively lower oil products. Preferably the amount of water added is maximally 95 wt %, more preferably at most 90 wt %, even more preferably at most 85 wt %, more preferably at most 80 wt %, even more preferably at most 33 wt %, and more preferably at most 25 wt %, based on the weight of the resulting food composition. It may be preferred that the water is added in an amount of at most 20 wt %. Any combination of ranges using these mentioned end points are considered to be part of the invention as well.

The pH of the composition can be adjusted by the use of e.g. spirit vinegar, as known in the art. This can be added into the water phase during step a) or during homogenisation step b), preferably during step b). Total vinegar is preferably added, and preferably present in the composition, in a total amount of from 1 to 20 wt %, preferably of from 1.5 to 10 wt %, preferably of from 2 to 5 wt %, based on the weight of the resulting composition.

It may be preferred, that the process comprises the steps of preparing an oil phase, comprising the vegetable oil and the preparation of a water phase, comprising water and the emulsifier, but preferably without the beetroot vinegar. The beetroot vinegar can be added to the water phase, but is preferably added during homogenisation, for optimal emulsifying results. As described above, the amount of beetroot vinegar, preferably of red beetroot vinegar (i.e. supsp. ruba), added is preferably of from 0.5 to 20 wt %, more preferably of from 0.5 to 10 wt %, even more preferably of from 1 to 5 wt %, even more preferably of from 1 to 3 wt %, based on the weight of the resulting composition.

Vegetable oil is preferably added in an amount of from 3 to 87 wt %, preferably of from 5 to 85 wt %, preferably of from 10 to 85, preferably of from 13 to 82 wt %, even more preferably of from 65 to 82 wt, most preferably of from 70 to 80 wt %, based on the weight of the resulting food composition.

Oil phase and water phase are typically combined, followed by homogenization. Preferably, homogenizing of the mixture of step a) is carried out till the oil droplets have a surface weighted mean diameter D3,3 of 10 or less than 10 micrometer, preferably of between 2 and 10 micron. This can suitably be done for example by a colloid mill, rotor-stator homogeniser, or high pressure homogenisator, or high shear mixing device as known in the art.

The beetroot vinegar as used in the invention, preferably red beetroot vinegar, is suitably produced by cleaning and peeling the roots of beetroot, comminuting them, removing the juice from the preferably comminuted root by a process that preferably involves pressing or centrifuging, as known in the art. The resulting juice may be filtered or sieved to remove sand or plant particles, as conventional in juice production.

The beetroot juice is consequently subjected to an ethanol fermentation process. This is suitably carried out as follows:
The alcoholic fermentation is initiated by the addition of yeast (preferably Saccharomyces Cerevisiae) to the juice,
The mixture is allowed to ferment, preferably for about 1 week. Fermentation is preferably continued till an ethanol level of between 5 to 15 wt % is reached in the fermented juice. Fermentation may be carried out until complete conversion of the naturally present sugars to ethanol. Typically, this results in an ethanol concentration in fermented juice of between 5 and 15 wt %. Fermentation is preferably carried out at a temperature of between 2° and 37 °C, preferably between 20 to 35 °C, even more preferably from 25 to 32 °C, under anaerobic conditions.

The resulting fermented beetroot juice comprises ethanol, typically in an amount of from 5 to 15 wt %, and is consequently subjected to an acetic acid fermentation process. This is suitably carried out as follows:
The acetous fermentation is preferably initiated by addition of acetic acid bacteria, preferably Acetobacter, such as Acetobacter aceti.
The mixture is preferably allowed to ferment for about 2 weeks. Fermentation can be continued preferably till an ethanol level in the fermentated juice is reached of at max 2 wt %, preferably maximum 1.5 wt %, preferably maximal 1 wt %, even more preferably maximum 0.5 wt %. It may be preferred that fermentation is carried out until complete conversion of the ethanol to acetic acid. Acetic fermentation is preferably carried out at 20 to 32 °C, preferably at a temperature of from 25 to 30 °C under aerobic conditions.

After the ethanol and/or acetic acid fermentation, pasteurization (e.g. 65-85 °C at e.g. 15 min) and/or clarification e.g. via filtration or centrifugation may be applied for keepability reasons.

Emulsifier and other ingredients described above in the context of the first aspect of the invention, are added in amounts as described there, based on the weight of the resulting emulsified food composition.

Preferably, the process of the invention comprises the steps of:
a) Providing a mixture comprising vegetable oil, emulsifier, water, and beetroot vinegar (vinegar from root of B. vulgaris subsp. vulgaris Conditiva Group), wherein the concentration of betaine in the beetroot vinegar is higher than 0.5 mg/g and wherein beetroot vinegar is added in an amount of from 0.5 to 3 wt %, preferably from 1 to 2.55 wt %, based on the weight of the resulting emulsified food composition,
b) Homogenizing to result in an oil-in-water emulsion, preferably with an oil droplet size D3,3 of below 10 micron,
wherein vegetable oil is added in an amount of from 3 to 87 wt %, based on the weight of the resulting composition.

According to this process, an emulsified food composition can be manufactured showing the advantages as desired, in particular, an emulsified food composition can be obtained, that shows an unexpected antioxidant effect while the colour and mouthfeel are not affected. Preferably, the colour and mouthfeel are similar as those in an equivalent composition free of red beetroot vinegar and using EDTA, as judged by the naked eye and by mouth. The composition is preferably free of grainy or sandy mouthfeel. Accordingly, the invention further relates to an oil-in-water emulsified food composition obtainable, preferably obtained, by the process of the invention.

### Use

In a further aspect, the present invention relates to the use of beetroot vinegar (i.e. from root of B. vulgaris subsp. vulgaris Conditiva Group), preferably red beetroot vinegar, typically having a betaine concentration of above 0.1 mg/g, preferably above 0.5 mg/g, to at least partially replace EDTA in an oil-in-water emulsified food composition comprising from 3 to 87 wt % of vegetable oil. Preferably, the present invention relates to the use of beetroot vinegar (from root of B. vulgaris subsp. vulgaris Conditiva Group), to achieve at least 50%, preferably at least 75%, even more preferably at least 80%, even more preferably at least 90% of the antioxidative effect as obtained by 75 ppm EDTA in an equivalent composition. It is preferred for example that said beetroot vinegar is used to replace from 75 to 100%, preferably 80 to 95%, more preferably 85 to 95% of the antioxidative effect as obtained by 75 ppm EDTA in an equivalent composition. This is for example derived from the time that an amount of oxygen is present in the headspace of a jar after a specific time period, such as set out in the methods part below. Such effect is preferably reached with the use of preferably 0.5 to 10 wt %, more preferably 1 to 5 wt %, more preferably 1 to 3 wt %, beetroot vinegar (i.e. from root of B. vulgaris subsp. vulgaris Conditiva Group), preferably red beetroot vinegar, based on the weight of the oil-in-water emulsion. EDTA is preferably below 0.008 wt %, preferably of from 0 to 0.007 wt %, preferably below 0.005 wt %, preferably below 0.002 wt %, preferably below 0.001 wt %, most preferably EDTA is 0 wt %, based on the weight of the oil in water emulsified food composition.

The invention will now be exemplified by the following, non-limiting examples:

### EXAMPLES

### Raw Materials

Water: demineralised water.
Rapeseed oil ex Cargill (Amsterdam, The Netherlands).
Sugar: sucrose white sugar W4 ex Suiker Unie (Oud Gastel, Netherlands).
Salt: NaCl suprasel ex Akzo Nobel (Amersfoort, Netherlands).
EDTA: Ethylenediaminetetraacetic acid, calcium disodium complex, dehydrate;
   Dissolvine E-CA-10 ex Akzo Nobel (Amersfoort, Netherlands).
Egg yolk: ex Bouwhuis Enthoven (Raalte, the Netherlands); contains 92% egg yolk and 8% kitchen salt.
Vinegar spirit 12% ex Kühne (Hamburg, Germany)
Red beetroot vinegar (homemade) 1: Homemade red beetroot vinegar, produced according to protocol below, using fresh beetroot juice.
Red beetroot vinegar (homemade) 2: Homemade red beetroot vinegar, produced ccording to protocol below, using commercial beetroot juice (Ernteband, Germany).
Red beetroot vinegar (commercial): Hirmann-Austria www.alles-essig.at.
Balsamic vinegar 1: Acetum SPA, Italy.
Balsamic vinegar 2: Coop, g′woon Balsamico di Modena. Filtered @10 kDa.
Balsamic vinegar 3: Coop, g′woon Balsamico di Modena, dosed at 0.2 wt %.
White beetroot vinegar: Hirmann-Austria www.alles-essig.at
Sugar beet vinegar: homemade vinegar produced from sugar beet juice according to protocol below.
Red beetroot juice: Ernteband, Germany.
Raspberry vinegar: Foodelicious, Rotterdam, the Netherlands.
Apple cider vinegar 1: Balsamic apple vinegar ex Vinagrerias Riojanas (Logroño, La Rioja, Spain).
Apple cider vinegar 3: Apple cider vinegar ex Wijnimport Van der Steen B V, Vught, the Netherlands.
Acetic acid solution 50%: Prepared in house, consisting of a 50:50 v/v % solution of acetic acid glacial (VWR, Amsterdam, the Netherlands) and demineralised water.
Plum vinegar, and Tomato vinegar: Pödör Öle und Essige, Vertrieb über Arteriomed GmbH, Grevenbroich, Germany.

All materials were obtained from the Netherlands unless stated otherwise.

### Methods

### Accelerated Shelf-Life Test to Follow Lipid Oxidation.

Vegetable oil is subjected to conditions which promote oxidation, without requiring the typical shelf life of 4 to 9 months of mayonnaise. Oxidation experiments are carried out during a period up to generally about 30 days, in some experiments up to 80 days, to follow the oxidation of the vegetable oil in oil-in-water emulsions.

Emulsion samples with various compositions are prepared (as described in the examples below) and 1 g of each sample is filled in a capped glass vial (20 mL volume) and kept in a temperature controlled oven at 50 °C.

The oxidation of triglycerides occurs in several steps, in which the first step is the most important. This first step is the lag phase, which is the phase where there is not much oxidation, and after this phase the oxidation starts to accelerate. This means that the amount of oxidation products rapidly starts to increase. The longer the lag phase, the slower the oxidation process, and the better the result.

### Oxygen Concentration in Headspace

To follow oxidation of fatty acids in emulsions in the experiments, the oxygen concentration is measured in the headspace of closed jars in which emulsions are stored to follow oxidation. The lower this concentration, the more oxygen is consumed for oxidation processes. The oxygen content is determined by taking a sample of gas from the headspace with a needle through a septum in the closed lid of the jar. The oxygen concentration in the sample is determined by gas analyser.

### Texture Measurements

The consistency of compositions according to the present invention can be measured using Stevens value or elastic modulus, which can be measured as follows:

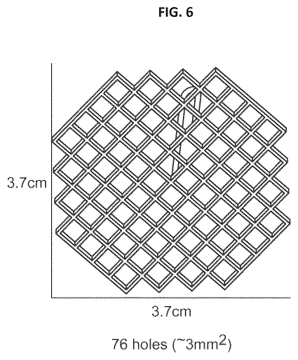

Thickness—Stevens value: the Stevens value is determined at 20 °C by using a Stevens LFRA Texture Analyser (ex Brookfield Viscometers Ltd., UK) with a maximum load/measuring range of 1000 grams, and applying a penetration test of 25 mm using a grid, at 2 mm per second penetration rate, in a cup having a diameter of 65 mm, that contains the emulsion; wherein the grid comprises square openings of approximately 3×3 mm, is made up of wire with a thickness of approximately 1 mm, and has a diameter of 40 mm. One end of a shaft is connected to the probe of the texture analyser, while the other end is connected to the middle of the grid. The grid is positioned on the flat upper surface of the emulsion in the cup. Upon starting the penetration test, the grid is slowly pushed downward into the emulsion by the texture analyser. The final force exerted on the probe is recorded, giving the Stevens value in gram. A drawing of the grid is given in FIG. 6. The grid is made from stainless steel, and has 76 holes, each hole having a surface area of approximately 3×3 mm.

### Consistency, Elastic Modulus.

These compositions are viscoelastic materials that exhibit both viscous and elastic characteristics when undergoing deformation. Viscous and elastic behaviour of materials can be measured by various instruments, of which a state of the art rheometer is a suitable instrument for the present compositions. Viscous and elastic properties by rheometer can be obtained by various methods. Oscillation measurements are suitable to characterize the compositions described in the present invention. In oscillation measurements, the elastic property is commonly characterized by the storage modulus G′ and the viscous property by the loss modulus G″. Both moduli are only valid in the linear deformation area, as known in the art.

### Measurement Protocol:

The AR 2000 EX rheometer (TA-Instruments) is a suitable state of the art rheometer used for the analysis of the compositions of the present invention. A 4 cm steel plate geometry with 1 mm gap is a suitable geometry. Other instrument settings are known by skilled in the art operators.

### Colour Measurement of the Used Vinegars

With the UltraScan VIS spectrophotometer from HunterLab (https://www.hunterlab.com/solutions/color-measurement/ultra-scan-vis) the transmission of the vinegars was measured. With the EasyMatch QC (version 4.83) software, the transmission is transferred into L* (lightness), a* (green/red) and b* (blue/yellow) values to determine the colour. The measured vinegars were not diluted before analysis.

### Colour Measurement of the Emulsion

To assess the effect of the vinegar on the color of the mayonnaise compositions, the L*a*b* values were measured of the vinegar or the mayonnaise compositions using a Hunterlab LabScan XE colorimeter. The color was expressed as L*a*b values, wherein L* indicates the lightness (L*=0 yields black and L*=100 indicates diffuse white), a* the green/red coordinate and b* is the yellow/blue coordinate, as known in the art. The difference in color ΔE of the mayonnaise with and without beetroot vinegar is calculated as ΔE*=SQRT(ΔL*²+Δa*²+Δb*2).

### Betaine by ¹H NMR

Quantitative analysis of betaine in vinegars and oil-in-water emulsified food compositions is carried out spectroscopically (¹H-NMR). Vinegars were measured as such for the NMR analysis. For the oil-in-water emulsified food compositions, the water layer was first extraxted. This could be done with organic solvents (e.g. hexane/isopropnal) or a freeze-thaw cycle to stimulate phase separation. The water layer was subsequently centrifuged at 17.000×g for 5 min and supernatant was used for the NMR analysis.

200 mg of sample (vinegar or water layer) was weighed and added with 3 ml of D₂O. 600 μl of such sample mixture was added with 100 μl of CSI (Chemical Shift Indicator) solution (consisting of 10.90 mg of 3-(trimethylsilyl)propionic-2,2,3,3-d₄ acid, sodium salt, 2.30 mg of difluorotrimethyl-silanyl-methyl)phosphonic acid and 30 ml of D₂O), 100 μl of EDTA-d₁₂ solution, and 300 μl of 0.2 M phosphate buffer. The sample mixture was homogenised and centrifuged at 15000 g for 10 minutes. 650 μl of the supernatant was transferred into 5-mm NMR tubes for analysis. 1D ¹H NMR spectra were recorded with a noesygppr1d pulse sequence on a Bruker Avance III 600 NMR spectrometer, equipped with a 5-mm cryo-probe. The probe was tuned to detect ¹H resonances at 600.25 MHz. The internal probe temperature was set to 298K. 128 scans were collected in 57K data points with a relaxation delay of 10 seconds, an acquisition time of 4 seconds and a mixing time of 100 ms. Low power water suppression (16 Hz) was applied for 0.99 seconds. The data were processed in Topspin software version 3.5 pl 1 (Bruker BioSpin GmbH, Rheinstetten, Germany). An exponential window function was applied to the free induction decay (FID) with a line-broadening factor of 0.15 Hz prior to the Fourier transformation. Manual phase correction and baseline correction was applied to all spectra. The spectra were referenced against the methyl signal of 3-(trimethylsilyl)propionic-2,2,3,3-d₄ acid, sodium salt (d 0.0 ppm). The trimethylglycine (betaine) peak at δ 3.3 ppm was used for the quantification.

### Betanin by LC-MS

Liquid chromatography High Resolution Accurate Mass Mass Spectrometry (LC-HRAM) analysis was achieved using an UltiMate 3000 RS chromatography system (Dionex, Sunnyvale, CA, USA). LC separation was performed using HSS C18 column (2.1 mm×100 mm, 1.7 μm; Waters, Etten-Leur, The Netherlands) with the following gradient of water (acidified with 0.025% TFA) and ACN: 0-1 min, 0.1% ACN; 1-12.5 min, 0.5-40% ACN linear; 12.5-15 min, 40-100% ACN linear; 15.5-17.5 min, 100% ACN isocratic. The flow rate was set to 0.35 mL/min, the column temperature was 40 °C, the temperature of the autosampler was 5 °C, and the injection volume was 5 μL. The LC was connected to a Q-Exactive Plus™ Hybrid Quadrupole-Orbitrap™ mass spectrometer (Thermo Fischer Scientific, MA, USA). To facilitate the ionization, a solution of acetic and propanol (50/50 v/v) was added post column via a syringe pump using a flow rate of 50 μl/min. The electrospray ion source operated in positive mode with the following parameters: the capillary temperature was 320 °C, the heater temperature was 350 °C, the sheath gas was set to 50 arbitrary units, the auxiliary gas was set to 12.5 arbitrary units.

The mass spectrometer was set to operate in full scan/data-dependant MS2 mode. Spectra were acquired at a resolution of 70.000 in the range from m/z 250 to 1500. For identification, the top five ions were acquired at a resolution of 17.500, with an isolation window of 2 m/z using the dynamic exclusion list set to 10 s. Calibration was achieved using Pierce™ Positive and Negative Ion Calibration Solution (Thermo Fischer). Data acquisition and processing was carried out using Xcalibur™ 3. Betanin eluted after 5 minutes, with a m/z of 551.15.

### Vinegar Production

Vinegar was produced by cleaning and peeling the roots of red beetroot or white beet, or sugar beet, as needed, comminuting them, removing the juice from the root by pressing or centrifuging. The resulting juice was sieved or centrifuged to remove any sand or plant particles, as conventional in juice production.
The alcoholic fermentation was initiated by the addition of a starter culture (Saccharomyces Cerevisiae).
The mixture was kept until complete conversion of the naturally present sugars to ethanol) at 30 °C under anaerobic conditions.
Once the conversion was completed, the alcoholic solution was pasteurized for 15 minutes at 85 °C.

The resulting fermented beet juice comprised ethanol, typically in an amount of from 5 to 15 wt %, and was consequently subjected to an acetic acid fermentation process. This was carried out as follows:
The acetous fermentation was also initiated by the addition of a starter culture (Acetobacter aceti).
The mixture was kept at 30 °C under aerobic conditions until the ethanol concentration was below 0.5%.
Then, the vinegar was pasteurized for 15 minutes at 85 °C and clarified by centrifugation, for keepability reasons.

### Example 1—Mayonnaises Containing Red Beetroot Vinegars

Mayonnaises were prepared according to the following recipes containing different red beetroot vinegars. Control compositions contained spirit vinegars or EDTA. Red beetroot vinegar (homemade) 1 was prepared with freshly derived juice from red beetroots, and preparing vinegar from it according to the protocol above. Red beetroot vinegar (homemade) 2 was prepared from commercially bought red beetroot juice (Ernteband, Germany), which was then fermented into vinegar according to the protocol mentioned above. Red beetroot vinegar (commercial) was a commercially bought red beetroot vinegar (Horman, Austria; www.alles-essig.at).

TABLE 1
Compositions of mayonnaises containing different beetroot vinegars.

| | Concentration [wt %] | | | | | | |
|---|---|---|---|---|---|---|---|
| Ingredient | #1 | #2 | #3 | #4 | #5 | #6 | #7 |
| Water | 15.37 | 15.05 | 12.74 | 13.47 | 10.96 | 11.29 | 15.37 |
| Oil (rapeseed) | 75 | 75 | 77.5 | 75 | 77.5 | 77.5 | 75 |
| Sugar | 1.30 | 1.30 | 1.28 | 1.30 | 1.28 | 1.28 | 1.30 |
| Salt | 1.20 | 1.20 | 1.49 | 1.20 | 1.49 | 1.49 | 1.20 |
| Egg yolk | 4.2 | 4.2 | 4.2 | 4.2 | 4.2 | 4.2 | 4.2 |
| Flavours | 0.33 | 0.2 | 0.29 | 0.33 | 0.29 | 0.29 | 0.33 |
| Spirit vinegar | 2.6 | 3 | 2.5 | 2 | 1.78 | 1.45 | 2.6 |
| Red beetroot vinegar | | | | 2.5 | | | |
| (homemade) 1 | | | | | | | |
| Red beetroot vinegar | | | | | 2.5 | | |
| (homemade) 2 | | | | | | | |
| Red beetroot vinegar | | | | | | 2.5 | |
| (commercial) | | | | | | | |
| CaNa₂EDTA | | | | | | | 0.0075 |

The mayonnaises were prepared at bench scale (0.4 kg emulsion). The aqueous phase was obtained by mixing water, egg, sucrose, salt and flavours. Subsequently oil was slowly added to the aqueous phase, while mixing with a high shear mixer (Silverson). The oil was added in about 10 minutes, while the mixing speed was slowly increased from about 1600 to about 7200 rpm. After the oil had been homogenised, and the emulsion had become smooth, vinegar was slowly added while the mixer was kept at 7200 rpm. The compositions had a pH of 3.8. The droplet size D3,3 was below 10 micrometer.

TABLE 2
Visual assessment of beetroot vinegars and mayonnaises

| Sample) | Appearance assessment mayonnaise |
|---|---|
| Spirit vinegar 1 | Off-white. Similar to commercial mayonnaise. |
| Spirit vinegar 2 | Off-white. Similar to commercial mayonnaise. |
| Spirit vinegar 3 | Off-white. Similar to commercial mayonnaise. |
| Red beetroot vinegar | Off-white. Similar to commercial mayonnaise. |
| (homemade) 1 | |
| Red beetroot vinegar | Off-white. Similar to commercial mayonnaise. |
| (homemade) 2 | |
| Red beetroot vinegar | Off-white. Similar to commercial mayonnaise. |
| (commercial) | |

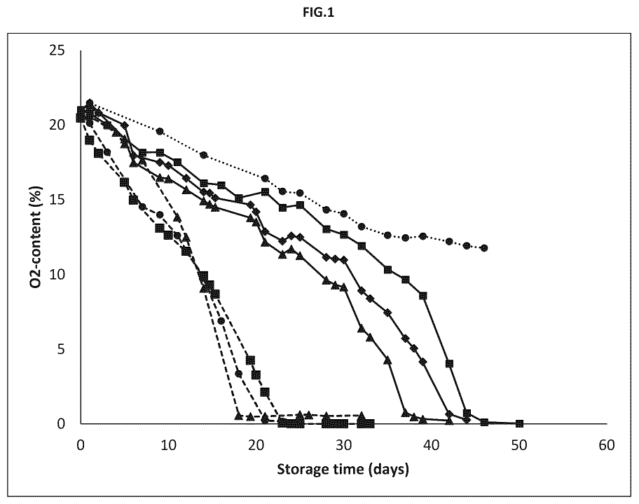

Oxygen concentration in the headspace during storage trial of mayonnaises at 50 °C was determined, to see the influence of the vinegar (see FIG. 1). Mayonnaises containing spirit vinegar shows a rapid decrease of oxygen concentration in the headspace, indicating that oxidation of oil is most rapid in these mayonnaises. The mayonnaises with red beetroot vinegar show a much slower decrease of oxygen concentration. The red beetroot vinegar 2 showed a lower antioxidative effect compared to red beetroot vinegars 1 and the commercial red beetroot vinegar, which may reflect the difference between the use of freshly prepared juice and commercially obtained juice. A mayonnaise containing 75 ppm EDTA was used as a reference, which is an amount as commercially used. Understandably, a higher concentration of beetroot vinegar in the mayonnaises would bring the observed values closer to or even over the values measured with EDTA. The color of the mayonnaises was off-white and similar to a commercial mayonnaise. This shows that red beetroot vinegar can be used as a strong EDTA replacer without negatively affecting the color appearance of the mayonnaise. The mouthfeel was the same for all tested mayonnaises and was smooth similar to a commercial mayonnaise.

The legend in FIG. 1 is as follows:
- -•- -: spirit vinegar 1
- -▴- - spirit vinegar 2
- -▪- - spirit vinegar 3
-▪- red beetroot vinegar (homemade) 1
-▴-red beetroot vinegar (homemade) 2
-♦- red beetroot vinegar (commercial)
. . . •. . . ppm EDTA

### Example 2—Mayonnaises Containing Balsamic Vinegars Vs. Red Beetroot Vinegar

Balsamic vinegars have been described as the strongest known antioxidative vinegars used in mayonnaises. Their disadvantage is their intense dark colour, which provides off-colour to oil-in-water emulsions like mayonnaise, which are typically white, and thereby compromises their use herein. In example 2, the antioxidative effect and the colour is compared for mayonnaises comprising several balsamic vinegars and red beetroot vinegars. Mayonnaises were prepared according to the following recipes, containing various types of balsamic vinegar. pH (3.8) was adjusted with spirit vinegar.

TABLE 3
Compositions of mayonnaises containing different grape balsamic vinegars and beetroot vinegar.

| | Concentration [wt %] | | | | | |
|---|---|---|---|---|---|---|
| Ingredient | #8 | #9 | #10* | #11 | #12 | #13 |
| Water | 15.37 | 15.37 | 14.69 | 13.98 | 15.26 | 13.47 |
| Oil (rapeseed) | 75 | 75 | 75 | 75 | 75 | 75 |
| Sugar | 1.30 | 1.3 | 1.3 | 1.3 | 1.3 | 1.30 |
| Salt | 1.20 | 1.2 | 1.2 | 1.2 | 1.2 | 1.20 |
| Egg yolk | 4.2 | 4.2 | 4.2 | 4.2 | 4.2 | 4.2 |
| Flavours | 0.33 | 0.33 | 0.24 | 0.33 | 0.33 | 0.33 |
| Spirit vinegar 1 | 2.6 | 0 | 0 | 1.49 | 2.51 | 0 |
| Spirit vinegar 4 | 0 | 2.6 | 0 | 0 | 0 | 0 |
| Balsamic vinegar 1 | 0 | 0 | 3 | 0 | 0 | 0 |
| Balsamic vinegar 2, 10 kDa filtered | 0 | 0 | 0 | 2.5 | 0 | 0 |
| Balsamic vinegar 3 | 0 | 0 | 0 | 0 | 0.2 | |
| Red beetroot vinegar (home made) 1 | 0 | 0 | 0 | 0 | 0 | 2.5 |

*pH adjusted with 0.37 wt % acetic acid solution (50% w/w)

These mayonnaises were prepared as in example 1. These mayonnaises were analysed for their oxidation behaviour and colour.

TABLE 4
Colour analysis of mayonnaises from Table 3.

| Sample | | colour |
|---|---|---|
| Spirit vinegar 1 | #8 | Off-white. Similar to commercial mayonnaise. |
| Spirit vinegar 4 | #9 | Off-white. Similar to commercial mayonnaise. |
| Balsamic vinegar 1 | #10 | Grey/brown off-coloured. Not acceptable. |
| Balsamic vinegar 2, 10 kDa filtered | #11 | Off-white. Similar to commercial mayonnaise. |
| Balsamic vinegar 3 | #12 | Off-white. Similar to commercial mayonnaise |
| Red beetroot vinegar (home made) 1 | #13 | Off-white. Similar to commercial mayonnaise |

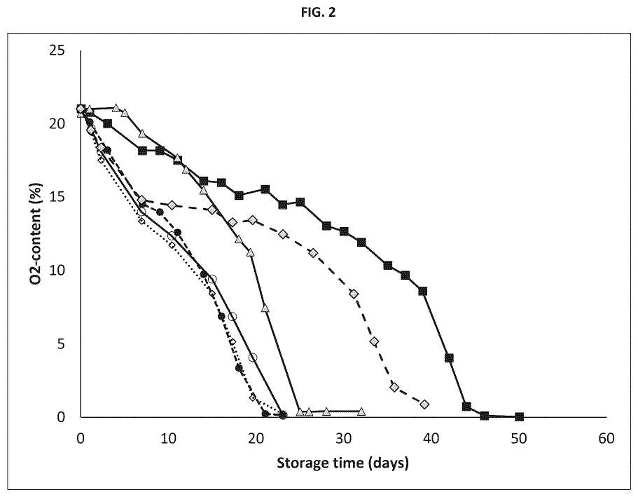

Oxygen concentration in headspace during storage trial of mayonnaises at 50 °C was determined, to see the influence of the vinegars (see FIG. 2). Mayonnaises #8 and #9 containing spirit vinegar show a rapid decrease of oxygen concentration in the headspace, indicating that oxidation of oil is most rapid in this mayonnaise. The mayonnaise #13 with red beetroot vinegar showed the slowest decrease of oxygen concentration. Balsamic vinegar 1 (mayonnaise #10) showed a significantly lower antioxidative effect than red beetroot vinegar (#13). Moreover, the color of mayonnaise #10 was not acceptable. Also, a second balsamic vinegar showed a lower antioxidant effect than the red beetroot vinegar, and again gave strong off-color in mayonnaise (data not shown). Filtering this balsamic vinegar, as described in WO2018/189709, (sample balsamic vinegar 2) resulted in a mayonnaise with acceptable color (#11). The antioxidant effect was below that of red beetroot vinegar (#13). Such a filtering step is commercially not feasible. Reducing the concentration of balsamic vinegar 2 (instead of filtering) (bals, vinegar 3, sample #12) resulted in a mayonnaise with acceptable color, but no antioxidant effect was observed anymore (effect similar to that of spirit vinegars, #8, #9). The use of beetroot vinegar overcomes the issues associated with the use of balsamic vinegar, i.e. off color and/or process complexity and shows superior anti-oxidant effect in oil in water emulsions.

Legend in FIG. 2 is as follows:
- -•- -: spirit vinegar 1 (#8)
--▪- red beetroot vinegar (homemade) 1 (#13)
--Δ- balsamic vinegar 1 (#10)
--o- spirit vinegar 4 (#9)
. . . ⋄. . . balsamic vinegar 3, 0.2 wt % dosage (#12)
-⋄- - - balsamic vinegar 2 (filtered) (#11)

### Example 3—Mayonnaises Containing Red Beetroot Vinegar Vs. Fruit and Vegetable Vinegars

WO2019/057474 describes vinegars with strong antioxidative effect in mayonnaises. In example 3, the antioxidative effect and the colour is compared for mayonnaises comprising the fruit and vegetable vinegars that performed best in WO2019/057474 versus red beetroot vinegar. Mayonnaises were prepared according to the following recipes, containing various types of vinegar and with the process of Example 1. pH (3.8) was adjusted with acetic acid or 12% spirit vinegar.

TABLE 5
Compositions of mayonnaises containing different fruit vinegars and red beetroot vinegar.

| | Concentration [wt %] | | | | |
|---|---|---|---|---|---|
| Ingredient | #14 | #15 | #16 | #17 | #18 |
| Water | 15.37 | 13.47 | 14.67 | 15.00 | 14.68 |
| Oil (rapeseed) | 75 | 75 | 75 | 75 | 75 |
| Sugar | 1.3 | 1.3 | 1.3 | 1.3 | 1.3 |
| Salt | 1.2 | 1.2 | 1.2 | 1.2 | 1.2 |
| Egg yolk | 4.2 | 4.2 | 4.2 | 4.2 | 4.2 |
| Flavours | 0.33 | 0.33 | 0.2 | 0.2 | 0.2 |
| Spirit vinegar 1 | 2.6 | 2 | 0 | 0 | 0 |
| Red beetroot vinegar (home made) 1 | 0 | 2.5 | 0 | 0 | 0 |
| Plum vinegar | 0 | 0 | 3 | 0 | 0 |
| Raspberry vinegar | 0 | 0 | 0 | 3 | 0 |
| Tomato vinegar | 0 | 0 | 0 | 0 | 3 |
| Acetic acid solution (50% w/w) | 0 | 0 | 0.43 | 0.55 | 0.42 |

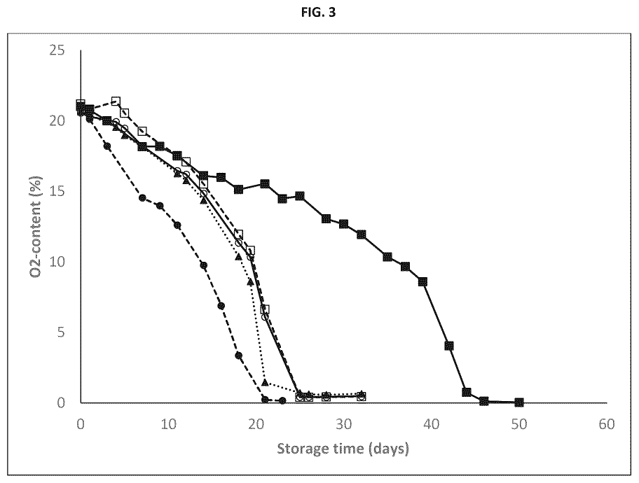

From FIG. 3, it becomes clear that red beetroot vinegar (sample #15) strongly outperformed tomato (sample #18), plum (sample #16) and raspberry vinegar (sample #17). Red beetroot vinegar showed the slowest decrease of oxygen concentration. Sample #14 is a negative control containing spirit vinegar 1. All mayonnaise samples showed the off-white colour of commercial mayonnaise.

Legend of FIG. 3 is as follows:
- -•- -: spirit vinegar 1 (#14)
--▪- red beetroot vinegar (homemade) 1 (#15)
--o- plum vinegar (#16)
. . . ▴. . . raspberry vinegar (#17)
- -□- - - tomato vinegar (#18)

### Example 4—Red Beetroot Vinegar Vs. White Beetroot and Sugar Beet

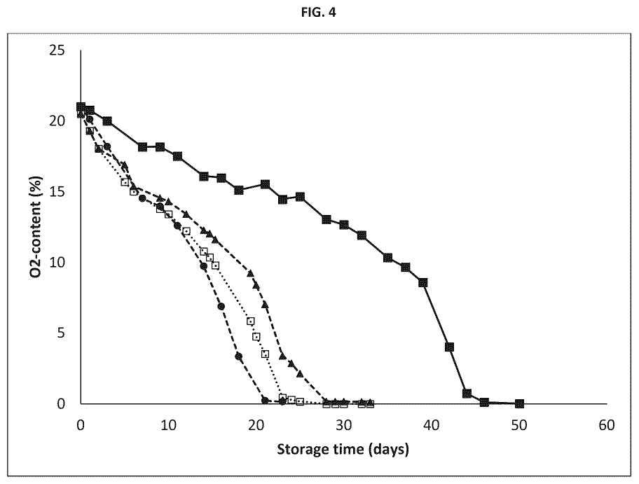

Example 4 illustrates the difference between mayonnaise containing red beetroot vinegar vs. vinegar prepared from sugar (spirit vinegar), vinegar from juice of sugar beet (Beta vulgaris vulgaris cultivar Altissima) and vinegar prepared from juice derived from white beets (Beta vulgaris vulgaris cultivar Altissima). Vinegar from sugar beet was prepared according to the protocol indicated above. Results are indicated in FIG. 4.

TABLE 6
Compositions of mayonnaises containing different beet vinegars.

| | Concentration [wt %] | | | |
|---|---|---|---|---|
| Ingredient | #19 | #20 | #21 | #22 |
| Water | 15.37 | 11.41 | 10.58 | 13.47 |
| Oil (rapeseed) | 75 | 77.5 | 77.5 | 75 |
| Sugar | 1.30 | 1.28 | 1.28 | 1.30 |
| Salt | 1.20 | 1.49 | 1.49 | 1.20 |
| Egg yolk | 4.2 | 4.2 | 4.2 | 4.2 |
| Flavours | 0.33 | 0.29 | 0.29 | 0.33 |
| Spirit vinegar 1 | 2.6 | 1.33 | 2.16 | 2 |
| White beetroot vinegar | 0 | 2.5 | 0 | 0 |
| Sugar beet vinegar (home made) | 0 | 0 | 2.5 | 0 |
| Red beetroot vinegar (home | 0 | 0 | 0 | 2.5 |
| made) 1 | | | | |

These mayonnaises were prepared as in example 1. These mayonnaises were analysed for their oxidation behaviour and colour. Spirit vinegar showed the fastest reduction of oxygen in the headspace. Sugar beet and white beetroot showed almost a similar pattern with a relatively fast decrease of oxygen. Red beetroot (Beta vulgaris vulgaris Conditiva Group) showed a strong antioxidative effect with relatively slow oxygen reduction from the headspace.

### Legend for FIG. 4:

- -•- -: spirit vinegar 1 (#19)
-▪- red beetroot vinegar (homemade) 1 (#22)
- -▴- - white beetroot vinegar (#20)
. . . □. . . sugar beet vinegar (#21)

### Example 5—Betaine, Betanin

Spirit vinegar, sugar beet vinegar (homemade) and red beetroot vinegar were tested for the presence of betaine, a compound characteristic for beet. Results are indicated in table 7. Spirit vinegar, which is prepared from sugar and not from beet juice does not contain betaine. Additionally, the presence of betanin was assessed, a red color present in red beetroot. The compound was not present in any of the vinegars. In line with the invention, the vinegar production from red beetroot juice decreases the red color. Indeed, beetroot juice shows an off-color in mayonnaise.

TABLE 7
assessment for betaine and betanin in the vinegar/juice

| | |
|---|---|
| Betain | Betanin |

| | | |
|---|---|---|
| Spirit vinegar 1 | not | — |
| | detectable | |

| | | | |
|---|---|---|---|
| Sugar beet vinegar (home made) | 0.5 | mg/g | — |
| Red beetroot vinegar (home made) 1 | 2 | mg/g | — |
| Red beetroot juice | 2 | mg/g | 10 mg/ml |

TABLE 8
Colour assessment of mayonnaises of Example 4

| Ingredient | Colour in mayonnaise |
|---|---|
| Spirit vinegar 1 | Off-white, similar to commercial mayonnaise. |
| Sugar beet vinegar (home made) | Off-white, similar to commercial mayonnaise. |
| Red beetroot vinegar (home made) 1 | Off-white, similar to commercial mayonnaise. |
| Red beetroot juice* | Non-acceptable: pink off colour |

*Red beetroot juice tested in same test mayonnaise composition

### Example 6-Beet Root Vinegar Vs. Apple Cider Vinegar

WO2019/057474 describes specific apple cider vinegars with high antioxidant capacity in oil in water emulsions. Red beetroot vinegar (homemade) 1 was compared to apple cider vinegar 1 and 3.

TABLE 9
Compositions of mayonnaises containing different vinegars.

| | Concentration [wt %] | | | |
|---|---|---|---|---|
| Ingredient | #23 | #24 | #25 | #26 |
| Water | 15.37 | 13.47 | 14.66 | 14.69 |
| Oil (rapeseed) | 75 | 75 | 75 | 75 |
| Sugar | 1.3 | 1.3 | 1.3 | 1.3 |
| Salt | 1.2 | 1.2 | 1.2 | 1.2 |
| Egg yolk | 4.2 | 4.2 | 4.2 | 4.2 |
| Flavours | 0.33 | 0.33 | 0.2 | 0.2 |
| Spirit vinegar 1 | 2.6 | 2 | | |
| Red beetroot vinegar (homemade) 1 | 0 | 2.5 | | |
| Apple cider vinegar 1 | | | 3 | |
| Apple cider vinegar 3 | | | | 3 |
| Acetic acid solution (50% w/w) | 0 | 0 | 0.44 | 0.41 |

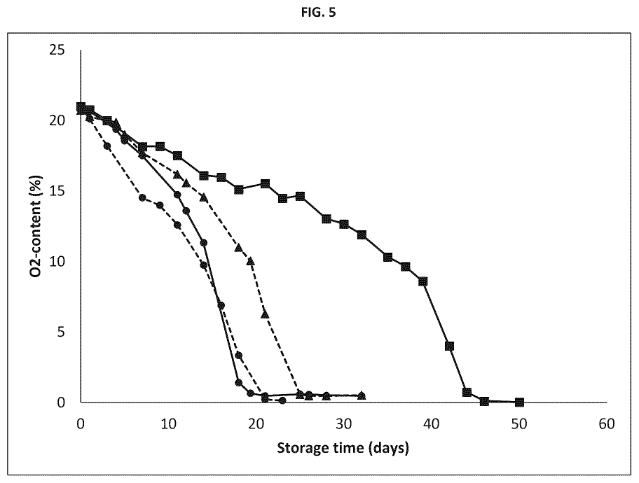

The mayonnaises were prepared as in Example 1. The compositions had a pH of 3.8. pH was adjusted using acetic acid solution or spirit vinegar. These mayonnaises were analysed for antioxidative effect and color. Results are depicted in FIG. 5. Apple cider vinegar 3 (#26) and spirit vinegar (#23) showed a rapid reduction in oxygen. Apple cider vinegar 1 (#25), showed a much slower reduction of oxygen compared to the spirit vinegar control and compared to apple cider vinegar 1. Red beetroot vinegar (#24) showed a significantly stronger antioxidative effect and reduction of oxygen was about 3.5 times slower.

TABLE 2
Visual assessment of samples in example 6

| | Appearance assessment |
|---|---|
| Sample) | mayonnaise |
| Spirit vinegar 1 (#23) | Off-white. Similar to |
| | commercial mayonnaise. |
| Red beetroot vinegar | Off-white. Similar to |
| (homemade) 1 (#24) | commercial mayonnaise. |
| Apple cider vinegar 1 (25) | Off-white. Similar to |
| | commercial mayonnaise. |
| Apple cider vinegar 3 (#26) | Off-white. Similar to |
| | commercial mayonnaise. |

### Legend for FIG. 5:

- -•- -: spirit vinegar 1 (#23)
-▪- red beetroot vinegar (homemade) 1 (#24)
- - ▴- - apple cider vinegar 1 (#25)
--•--: Apple cider vinegar 3 vinegar (#26)

1. An oil-in-water emulsified food composition comprising:
from 3 to 87 wt % of vegetable oil,
water,
an oil-in-water emulsifier,
a beetroot vinegar from Beta vulgaris subsp. vulgaris, Conditiva Group is comprising a betaine, and optionally, betanin,
wherein the food composition has a pH of from 2 to 5,
wherein a concentration of the betanin in the composition is from 0 to 0.002 wt %, based on the weight of the food composition.

2. The oil-in-water emulsified food composition according to claim 1, wherein the beetroot vinegar is red beetroot vinegar.

3. The oil-in-water emulsified food composition according to claim 1, wherein the beetroot vinegar is present in an amount of from 0.5 to 20 wt %, based on the weight of the food composition.

4. The oil-in-water emulsified food composition according to claim 1, wherein the betaine is present in an amount of from 0.9 to 3.5 mg/g, based on the weight of said vinegar.

5. The oil-in-water emulsified food composition according to claim 1, wherein the betaine is present in an amount of from 0.003 to 0.7 mg/g, based on the weight of the food composition.

6. The oil-in-water emulsified food composition according to claim 1 further comprising ethylenediaminetetraaceticacid in a concentration that is lower than 0.007 wt %, based on the weight of the food composition.

7. The oil-in-water emulsified food composition according to claim 1, wherein the emulsifier is selected from the group consisting of egg-derived emulsifier, dairy protein, botanical protein, OSA starch, and mixtures thereof.

8. The oil-in-water emulsified food composition according to claim 1, wherein the L* color value according to a CIE L*a*b* scale for the oil-in-water emulsion is of from 50 to 95.

9. The oil-in-water emulsified food composition according to claim 1, wherein ΔE of the food composition is from 0 to 30.

10. The oil-in-water emulsified food composition, according to claim 1, wherein the food composition is a mayonnaise or a salad dressing.

11. The oil-in-water emulsified food composition, according to claim 1, wherein oil droplets in the emulsion have a surface weighted mean diameter D3,3 of less than 10 micrometer.

12. A process to provide an oil-in-water emulsion, the process comprising the steps of:
a) providing a mixture comprising
vegetable oil,
water,
beetroot vinegar from Beta vulgaris subsp. vulgaris, Conditiva Group, wherein the vinegar comprises betaine,
oil-in-water emulsifier,
b) homogenizing to result in an oil-in-water emulsion.

13. The process according to claim 12, wherein the beetroot vinegar is added in an amount of from 0.5 to 20 wt % based on the weight of the resulting food composition.

14. The process according to claim 12, wherein,
the vegetable oil is added in an amount of from 3 to 87 wt %,
the beetroot vinegar is added in an amount of from 0.5 to 10 wt %, and
wherein the oil droplets in the emulsion have a surface weighted mean diameter D3,3 of less than 10 micrometer.

15. (canceled)

16. The oil-in-water emulsified food composition according to claim 3, wherein the beetroot vinegar is present in an amount of from 1 to 3 wt %, based on the weight of the food composition.

17. The oil-in-water emulsified food composition according to claim 1, wherein ethylenediaminetetraaceticacid is absent from the food composition.

18. The oil-in-water emulsified food composition according to claim 7, wherein the emulsifier is selected from the group consisting of phospholipid, whey protein, casein, algae protein, legume protein, OSA starch and mixtures thereof.

19. The oil-in-water emulsified food composition according to claim 8, wherein the L* color value according to the CIE L*a*b* scale for the oil-in-water emulsion is of from 85 to 95.

20. The process according to claim 12, wherein the beetroot vinegar is added in an amount of from 1 to 3 wt %, based on the weight of the resulting food composition.

21. The process according to claim 12, wherein the beetroot vinegar is added in an amount of from 1 to 5 wt %.
